(19) United States
(12) Patent Application Publication
(10) Pub. No.: US 2024/0054110 A1
(43) Pub. Date: Feb. 15, 2024

(54) METHOD, APPARATUS AND ELECTRONIC DEVICE FOR CREATING QUANTUM VEHICLE MODEL PARTS BASIC DATABASE, AND STORAGE MEDIUM

(71) Applicant: DATA ENLIGHTEN TECHNOLOGY (BEIJING) CO., LTD, Beijing (CN)

(72) Inventors: Kai ZHOU, Beijing (CN); Wei LI, Beijing (CN); Enjun CHANG, Beijing (CN); Jian KANG, Beijing (CN); Wen ZHANG, Beijing (CN); Xinglong WANG, Beijing (CN); Qi SUN, Beijing (CN)

(21) Appl. No.: 18/467,440

(22) Filed: Sep. 14, 2023

Related U.S. Application Data
(63) Continuation of application No. PCT/CN2022/100974, filed on Jun. 24, 2022.

(30) Foreign Application Priority Data
Dec. 7, 2021 (CN) 202111485322.6

(51) Int. Cl. G06F 16/21; G06F 16/22; G06Q 30/0203

(52) U.S. Cl. CPC G06F 16/21; G06F 16/22; G06Q 30/0203

(57) ABSTRACT

Provided is a method for creating a quantum vehicle model parts basic database. The method includes: obtaining all parts codes of each vehicle identification number by using a data loading engine, and sorting all parts codes of said each vehicle identification number as a parts code set corresponding to said each vehicle identification number; merging a plurality of the vehicle identification numbers satisfying a predetermined condition; determining, by using a preset verification model, whether merging results are qualified; and encoding the merging results when it is determined that the merging results are qualified, so as to obtain the quantum vehicle model parts basic database taking the merging results as a dimension. Therefore, under the premise of ensuring that the data accuracy is completely the same as the accuracy of the single vehicle identification numbers, the disadvantage that the amount of data for single vehicle identification number storage is too large to be called can be avoided, and the accuracy and the practicability are integrated.

### CROSS-REFERENCE TO RELATED APPLICATIONS

This is a PCT Bypass continuation application claiming priority under 35 U.S.C. § 120 to International Application No. PCT/CN2022/100974 filed on Jun. 24, 2022, and claims priority under 35 U.S.C. § 119 to Chinese Patent Application No. 202111485322.6 filed on Dec. 7, 2021, the entire content of each is incorporated herein by reference.

### TECHNICAL FIELD

The presently disclosed subject matter relates to the field of automobile information technology and vehicle model parts data, and more particularly to a method, an apparatus and an electronic device for creating a quantum vehicle model parts basic database, and a storage medium.

### BACKGROUND

A quantum vehicle model parts basic database (hereinafter referred to as a quantum library) is a vehicle model parts basic database that classifies the vehicle models by taking the consistency of the codes of the whole vehicle parts of an automobile as a dimension, and it can be applied to many fields.

For example, with the rapid development of China's insurance industry, after the insurance rate reform implemented on Sep. 19, 2020, the compensation cost of insurance companies is increased. At present, the data foundation of the insurance companies is weak, and the data accuracy and standardization degree have room for improvement. Therefore, it is desired in the industry to provide the architecture with high underlying data accuracy, unified data standard, and open underlying data fusion. With continuous changes of the business scenarios, the digital management accuracy is continuously improved, and improving the efficiency through an automatic management has widely become a consensus. Therefore, it has become the main development direction in the future to make the underlying basic data separated from the application layer tools, and to focus on improving the business service and reducing the repeated construction cost.

However, the traditional vehicle model parts database is not fine enough in granularity and not high enough in accuracy, and the data accuracy of the parts code (OE) under the vehicle model cannot be the same as that of the single VIN (vehicle identification number or vehicle frame number). Therefore, processing and analysis based on such a traditional vehicle model parts database also have great limitations, and the high data accuracy cannot be obtained.

For the general existing full-amount vehicle model library, the VIN amount of its mainstream brands underwriting vehicles will reach a hundred-million level. If it is calculated according to an average adaptation of 3000 parts per vehicle, more than 300 billion mass data will be generated in the case that 3000 OEs and attribute information thereof to be corresponding to the hundred-million VINs. are completely calculated and stored in the library, which not only brings great challenges to the storage, but also cannot realize the multi-concurrency efficient query. The key is that the huge amount of VINs makes it impossible for users to maintain any data in the VIN dimension.

Moreover, for the general existing full-amount vehicle model library, in scenarios such as loss assessment or risk control, after performing VIN parsing, a customer uses various methods to select parts (including clicking, circling, standard name, OE query, etc.), sends the input parameters of the VIN+a certain query method to a dynamic operation engine to obtain the full-amount OEs under the VIN, retrieves all attributes corresponding to each OE, including standard names, prices, replacement relationships, working hours, etc., and presents the OEs and OE attribute information to the product end or returns them to the customer.

It should be noted that the parts code (OE) refers to the serial number used by the automobile production plant to facilitate the management of the parts, and each parts code corresponds to a unique product. However, for the same product, since it is equipped on different vehicle models, there may be several different parts codes. Through the parts codes, the type (electric generator, starter, or motor parts, etc.), specific performance and detailed parameter of the product can be queried, and the specific automobile brand, vehicle model series, and ex-factory ages as well as the specific model of the corresponding engine and the like applied by the product can also be known.

### SUMMARY

The presently disclosed subject matter is provided in view of the above problems, and the object of the presently disclosed subject matter lies in providing a quantum vehicle model parts basic database, which solves the contradiction between “completely retaining the VIN accuracy” and “the amount of data being too large to use, resulting in no business attributes” in the traditional basic database. Therefore, under the premise of ensuring that the data accuracy is completely the same as the single VIN accuracy, the disadvantage that the amount of data for single VIN storage is too large to be called can be avoided, and the accuracy and the practicability are integrated. Specifically, the quantum library of the presently disclosed subject matter encodes and merges all vehicle parts, and then under the premise of ensuring that the data accuracy is unchanged, provides the most fine-grained vehicle model parts query capability, which greatly reduces the amount of the vehicle model maintenance and makes the amount of data reduced from a hundred-million level to a million level, thereby facilitating secondary processing and trend mining of data in different usage scenarios. In addition, for users in application scenarios such as insurance, they have their own confidentiality requirements for data, while the traditional high-accuracy requirements lead to the need to use a single VIN to retrieve a third-party service for parts query, and this process involves service replacement, interface adjustment and docking, etc., so that a large amount of manpower and material resources are occupied. In contrast, the quantum library of the presently disclosed subject matter can be statically deployed locally, thus avoiding customer data leakage on the basis of ensuring data accuracy.

According to the first aspect of the presently disclosed subject matter, a method for creating a quantum vehicle model parts basic database is provided. The method includes: obtaining all parts codes of each vehicle identification number in a database by using a data loading engine, and sorting all parts codes of said each vehicle identification number as a parts code set corresponding to said each vehicle identification number; merging a plurality of the vehicle identification numbers satisfying a predetermined condition; determining, by using a preset verification model, whether merging results are qualified; and encoding the merging results when it is determined that the merging results are qualified, so as to obtain the quantum vehicle model parts basic database taking the merging results as a dimension.

According to the embodiment, the following technical effects can be obtained: the quantum library is obtained by processing and calculation on the massive hundred-billion-level OEs of the hundred-million-level VINs with a high-performance calculation architecture; the massive data of the quantum library are stored in a unique high compression data format, and 100 TB data are compressed to 1 TB to be basically stored in the database, which solves the contradiction between “completely retaining the VIN accuracy” and “the amount of data being too large to use, resulting in no business attributes” in the traditional basic database. Therefore, under the premise of ensuring that the data accuracy is completely the same as the single VIN accuracy, the disadvantage that the amount of data for single VIN storage is too large to be called can be avoided, and the accuracy and the practicability are integrated. Specifically, the quantum library of the presently disclosed subject matter encodes and merges all vehicle parts, and then under the premise of ensuring that the data accuracy is unchanged, provides the most fine-grained vehicle model parts query capability, which greatly reduces the amount of the vehicle model maintenance and makes the amount of data reduced from a hundred-million level to a million level, thereby facilitating secondary processing and trend mining of data in different usage scenarios.

Preferably, according to an embodiment of the presently disclosed subject matter, the method further includes: replacing different parts codes representing the same product with standard parts codes in the parts code set after merging the plurality of the vehicle identification numbers, so as to obtain a standardized parts code set; and re-merging the vehicle identification numbers that have been merged, according to the predetermined condition based on the replaced standardized parts code set.

According to the embodiment, the following technical effects can be obtained: the OE set can be standardized to further merge VINs, thereby further reducing the data storage amount under the premise of ensuring that the data accuracy is completely the same as that of the single VIN.

Preferably, according to an embodiment of the presently disclosed subject matter, said merging a plurality of the vehicle identification numbers satisfying a predetermined condition includes: merging a plurality of the vehicle identification numbers corresponding to the same parts code set.

According to the embodiment, the following technical effects can be obtained: the same data accuracy as a single VIN can be obtained, thus integrating accuracy and practicability.

Preferably, according to an embodiment of the presently disclosed subject matter, said determining, by using a preset verification model, whether merging results are qualified includes: determining whether a preset index under the merging results reaches a predetermined threshold so as to determine whether the merging results are qualified; and calling a sales vehicle model database to obtain sales version information corresponding to all of the vehicle identification numbers under each of the merging results, and determining whether the sales version information corresponding to all of the vehicle identification numbers under each of the merging results is unique so as to determine whether the merging results are qualified.

According to the embodiment, the following technical effects can be obtained: each index and its threshold can be flexibly set according to the data characteristics, thereby improving the verification efficiency, and the VIN-SID database can be called to verify the relationship between the merged VIN-key_MD5 (the merging result) and key_MD5-OE again, so as to improve the accuracy of the data.

Preferably, according to an embodiment of the presently disclosed subject matter, the method further includes: manually fixing unqualified data when it is determined that the merging results are unqualified.

According to the embodiment, the following technical effects can be obtained: more sufficient data samples can be obtained, thereby improving data accuracy.

Preferably, according to an embodiment of the presently disclosed subject matter, the method further includes: selectively transmitting and saving the quantum vehicle model parts basic database to a user internal network, for static deployment to the user internal network; taking the vehicle identification numbers as an input parameter, and calling a quantum library query engine to query the quantum vehicle model parts basic database, so as to obtain the merging results corresponding to the vehicle identification numbers as the input parameter, and then obtain parts codes and attributes thereof corresponding to the merging results.

According to the embodiment, the following technical effects can be obtained: users may obtain only a part (privatizable deployment data) that the user needs in the aforesaid quantum vehicle model parts basic database according to their own requirements, without needing the entire database with a large amount of data storage. Moreover, if users need to use the VIN-OE data in a certain link that requires data such as loss assessment/risk control, etc., they can query the corresponding VIN-VID relationship directly by inputting VIN in an intranet, and further query the corresponding relationship of VID-OE, so as to directly query the OE and relevant attribute information thereof corresponding to the VIN in the privatizable deployment data of the intranet, without accessing the extra net, thereby achieving the good effects of rapid, safe, efficient and stable data query, and facilitating data upgrading and maintenance through network transmission. Additional information such as a parts name may be further used for screening to obtain a final query result.

Preferably, according to an embodiment of the presently disclosed subject matter, the method further includes: establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

According to the embodiment, the following technical effects can be obtained: the corresponding OE and attribute information thereof can be quickly and efficiently obtained in a case of inputting the vehicle model rather than the VIN for query, so that it is convenient for users to input various types of information for query according to their needs, and the user convenience is improved. It needs to be pointed out that the relationship between other relevant parameters and VID can be established without being limited to the vehicle model information, and then the VID and the corresponding OE and attributes thereof can be queried by inputting the other parameters.

According to the second aspect of the presently disclosed subject matter, an apparatus for creating a quantum vehicle model parts basic data base is provided, which can obtain substantially the same technical effect as the method described above, and is no longer repeated here.

The apparatus for creating a quantum vehicle model parts basic database includes:
a parts code set obtaining module, configured to obtain all parts codes of each vehicle identification number in a database by using a data loading engine, and sort all parts codes of said each vehicle identification number as a parts code set corresponding to said each vehicle identification number; a merging module, configured to merge a plurality of the vehicle identification numbers satisfying a predetermined condition; a verification module, configured to determine, by using a preset verification model, whether merging results are qualified; and a merging result generation module, configured to encode the merging results when it is verified that the merging results are qualified, so as to obtain the quantum vehicle model parts basic database taking the merging results as a dimension.

Further preferably, the apparatus for creating a quantum vehicle model parts basic database further includes: a parts code set replacement module, configured to replace different parts codes representing the same product with standard parts codes in the parts code set after merging the plurality of the vehicle identification numbers, so as to obtain a standardized parts code set; and a re-merging module, configured to re-merge the vehicle identification numbers that have been merged, according to the predetermined condition based on the replaced standardized parts code set.

Further preferably, the merging module merges a plurality of the vehicle identification numbers corresponding to the same parts code set.

Further preferably, the verification module may include: an index verification unit, configured to determine whether a preset index under the merging results reaches a predetermined threshold to determine whether the merging results are qualified; and a sales version information verification unit, configured to call a sales vehicle model database so as to obtain sales version information corresponding to all of the vehicle identification numbers under each of the merging results, and determine whether the sales version information corresponding to all of the vehicle identification numbers under each of the merging results is unique so as to determine whether the merging results are qualified.

Further preferably, the apparatus for creating a quantum vehicle model parts basic database may further include: a manual optimization module, configured to manually fix unqualified data when it is determined that the merging results are unqualified.

Further preferably, the apparatus for creating a quantum vehicle model parts basic database further includes: a static deployment module, configured to selectively transmit and save the quantum vehicle model parts basic database to a user internal network, for static deployment to the user internal network.

Further preferably, the apparatus for creating a quantum vehicle model parts basic database further includes: a quantum library query engine calling module, configured to take the vehicle identification numbers as an input parameter, and call the quantum library query engine to query the quantum vehicle model parts basic database, so as to obtain the merging results corresponding to the vehicle identification numbers as the input parameter, and then obtain parts codes and attributes thereof corresponding to the merging results.

Further preferably, the apparatus for creating a quantum vehicle model parts basic database further includes: a vehicle model correlation module, configured to establish a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

According to the third aspect of the presently disclosed subject matter, an electronic device for creating a quantum vehicle model parts basic database is provided. The electronic device includes a storage unit storing programs and a processing unit, wherein the processing unit executes the programs to implement each step in the method according to any one of the first aspect.

According to the fourth aspect of the presently disclosed subject matter, a computer-readable storage medium is provided, wherein, the storage medium has programs stored thereon, the programs being executed to implement each step in the method according to any one of the first aspect.

The technical solution of the presently disclosed subject matter will be further described in detail below in conjunction with the accompanying drawings and preferred embodiments of the presently disclosed subject matter, and the beneficial effects of the present intention will be further clarified.

### BRIEF DESCRIPTION OF THE DRAWINGS

The accompanying drawings described herein are used to provide a further understanding of the presently disclosed subject matter and constitute a part of the presently disclosed subject matter, but their descriptions are merely used to explain the presently disclosed subject matter, and do not constitute improper limitations on the presently disclosed subject matter.

FIG. 1 is a schematic principle diagram for illustrating main steps of a method for creating a quantum vehicle model parts basic database according to a preferred embodiment of the presently disclosed subject matter;

FIG. 2 is a schematic flowchart of a method for creating a quantum vehicle model parts basic database according to a preferred embodiment of the presently disclosed subject matter;

FIG. 3 is a schematic flowchart of a method for creating a quantum vehicle model parts basic database according to a preferred embodiment of the presently disclosed subject matter;

FIG. 4 is a schematic flowchart of a method for creating a quantum vehicle model parts basic database according to a preferred embodiment of the presently disclosed subject matter;

FIG. 5 is a schematic flowchart of a method for creating a quantum vehicle model parts basic database according to a preferred embodiment of the presently disclosed subject matter;

FIG. 6 is a schematic flowchart of a method for creating a quantum vehicle model parts basic database according to a preferred embodiment of the presently disclosed subject matter;

FIG. 7 is a schematic diagram for illustrating a static deployment step of a method for creating a quantum vehicle model parts basic database according to a preferred embodiment of the presently disclosed subject matter;

FIG. 8 is a schematic flowchart of a method for creating a quantum vehicle model parts basic database according to a preferred embodiment of the presently disclosed subject matter;

FIG. 9 is a block diagram showing a configuration of an apparatus for creating a quantum vehicle model parts basic database according to a preferred embodiment of the presently disclosed subject matter;

FIG. 10 is a block diagram showing a configuration of an apparatus for creating a quantum vehicle model parts basic database according to a preferred embodiment of the presently disclosed subject matter;

FIG. 11 is a block diagram showing a configuration of an apparatus for creating a quantum vehicle model parts basic database according to a preferred embodiment of the presently disclosed subject matter;

FIG. 12 is a block diagram showing a configuration of an apparatus for creating a quantum vehicle model parts basic database according to a preferred embodiment of the presently disclosed subject matter;

FIG. 13 is a block diagram showing a configuration of an apparatus for creating a quantum vehicle model parts basic database according to a preferred embodiment of the presently disclosed subject matter;

FIG. 14 is a block diagram showing a configuration of an apparatus for creating a quantum vehicle model parts basic database according to a preferred embodiment of the presently disclosed subject matter;

FIG. 15 shows an exemplary system architecture, to which a method or an apparatus for creating a quantum vehicle model parts basic database according to embodiments of the presently disclosed subject matter may be applied; and

FIG. 16 is a schematic structural diagram of a computer system suitable for implementing a method or an apparatus for creating a quantum vehicle model parts basic database according to embodiments of the presently disclosed subject matter.

### DETAILED DESCRIPTION

The technical solution of the present intention will be described below clearly and completely in conjunction with the specific embodiments and corresponding accompanying drawings of the presently disclosed subject matter. Apparently, the described embodiments are merely some preferred embodiments rather than all embodiments of the presently disclosed subject matter. Based on the embodiments of the presently disclosed subject matter, all other embodiments obtained by those of ordinary skill in the art without creative efforts shall fall within the protection scope of the presently disclosed subject matter.

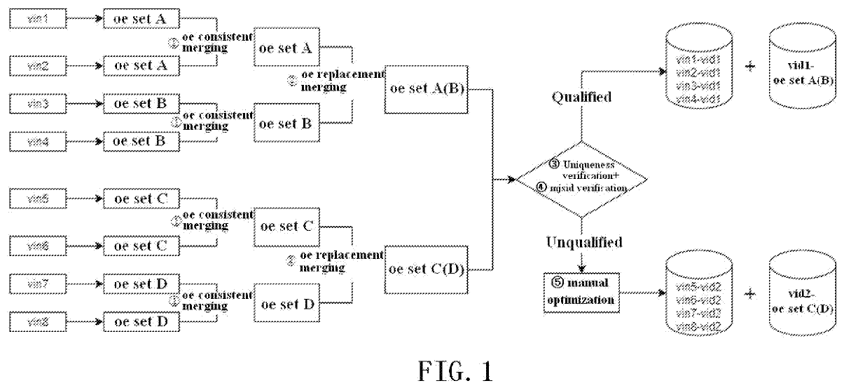

The method for creating a quantum vehicle model parts basic database according to a preferred embodiment of the presently disclosed subject matter will be described and explained below in conjunction with FIGS. 1-8.

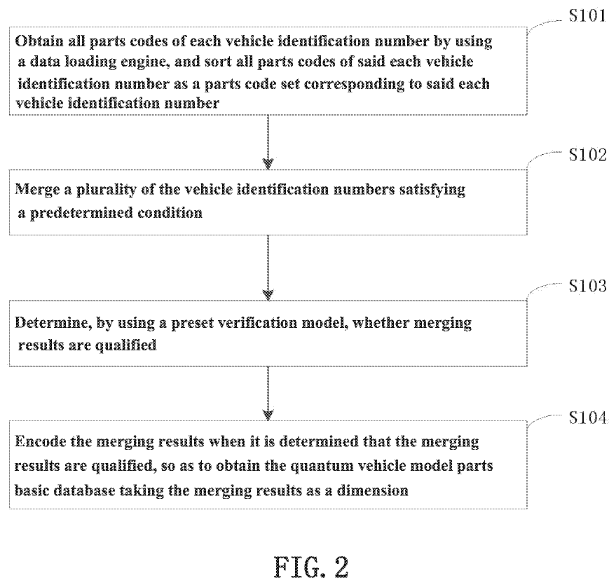

FIG. 2 is a schematic flowchart of a method for creating a quantum vehicle model parts basic database according to a preferred embodiment of the presently disclosed subject matter. As shown in FIG. 2, the method for creating a quantum vehicle model parts basic database according to an embodiment of the presently disclosed subject matter includes: S101, an OE set obtaining step; S102, a merging step; S103, a verification step; and S104, a VID generation step.

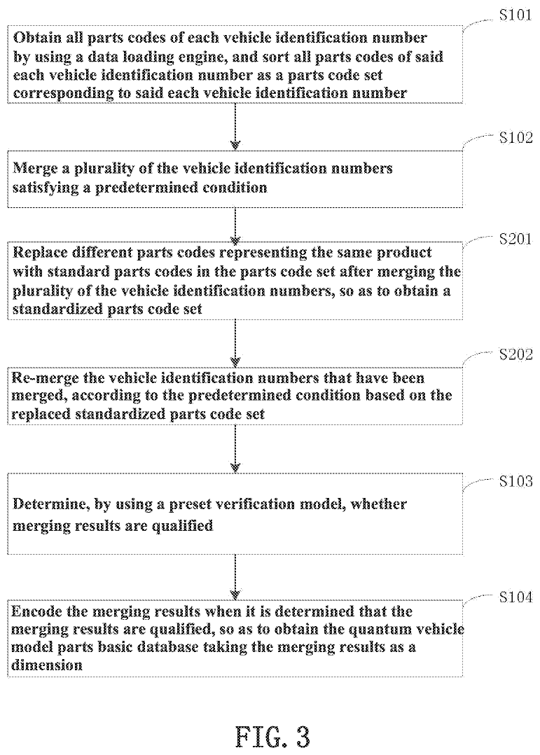

As shown in FIG. 3, as a preferred embodiment, the method for creating a quantum vehicle model parts basic database according to the presently disclosed subject matter further includes: Step S201, an OE set replacement step; and Step S202, a re-merging step.

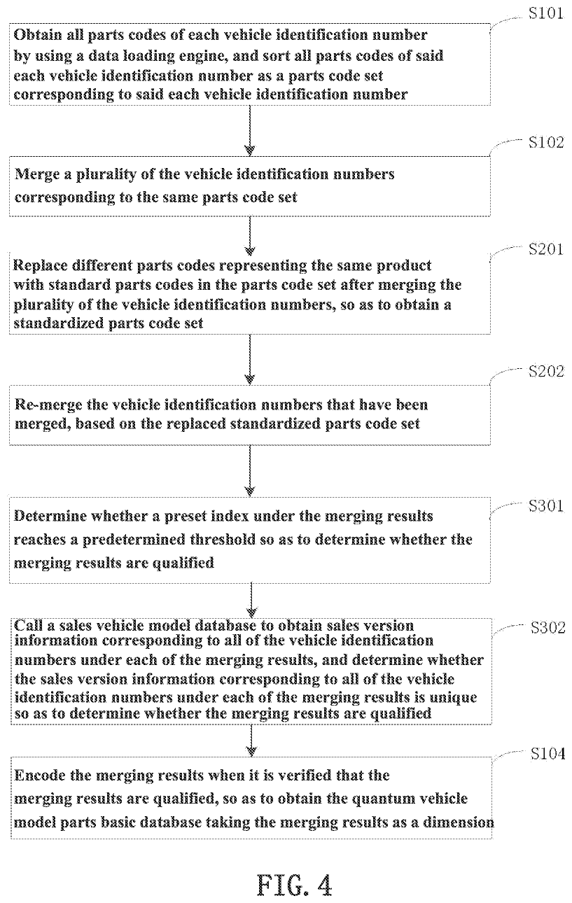

As shown in FIG. 4, as a preferred embodiment, the verification step S103 according to the presently disclosed subject matter further includes: Step S301, an index verification step; and Step S302, a sales version information verification step.

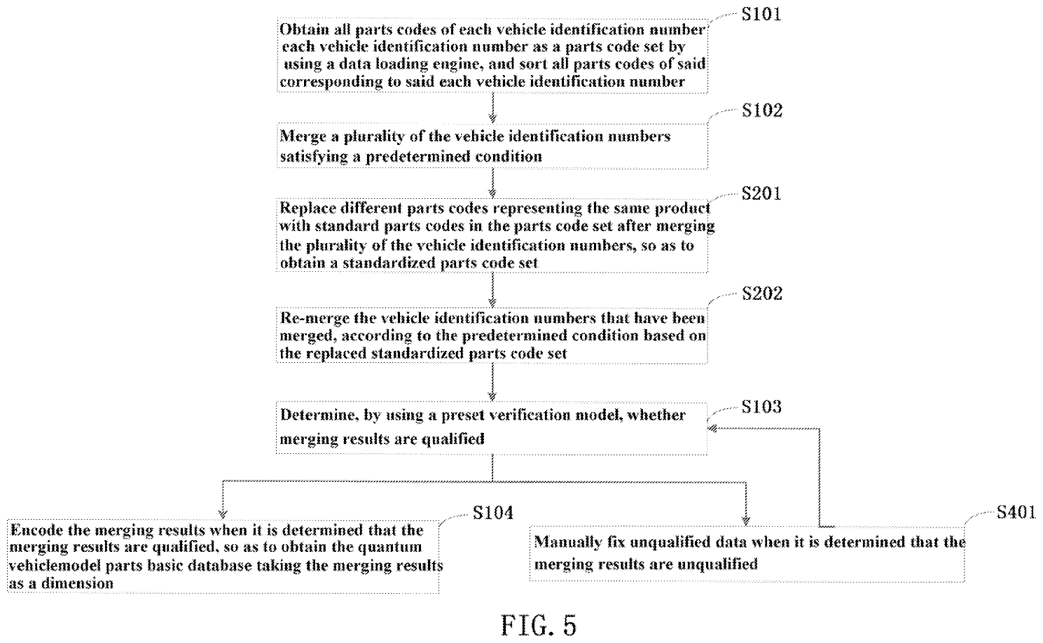

As shown in FIG. 5, as a preferred embodiment, the method for creating a quantum vehicle model parts basic database according to the presently disclosed subject matter further includes: Step S401, a manual optimization step.

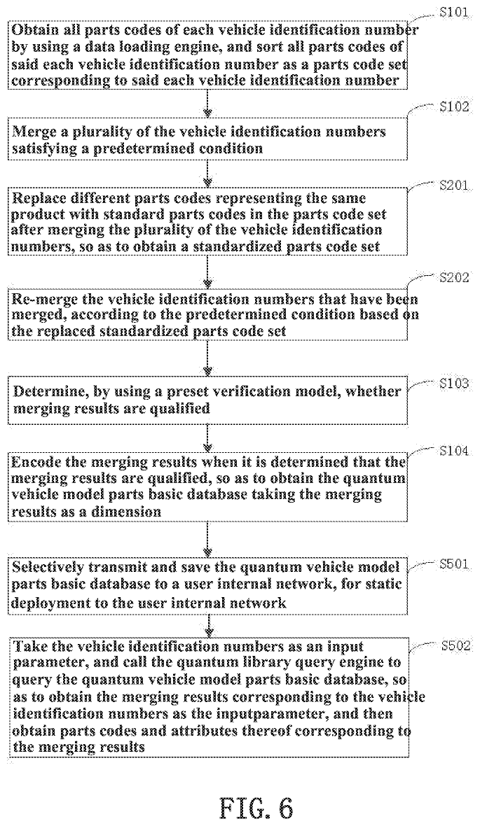

As shown in FIG. 6, as a preferred embodiment, the method for creating a quantum vehicle model parts basic database according to the presently disclosed subject matter further includes: Step S501, a static deployment step; and Step S502, a quantum library query engine calling step.

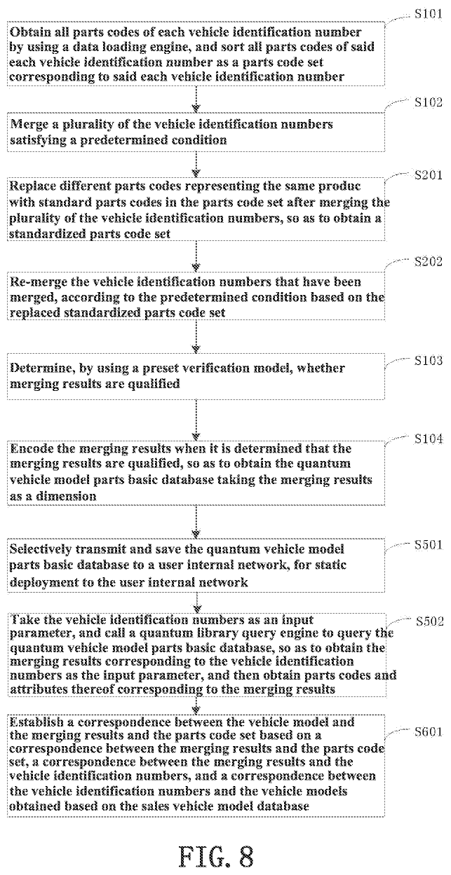

As shown in FIG. 8, as a preferred embodiment, the method for creating a quantum vehicle model parts basic database according to the presently disclosed subject matter further includes: Step S601, a vehicle model correlation step.

Each step above will be described below in detail.

S101 is an OE set obtaining step.

All parts codes of each vehicle identification number in a database are obtained by using a data loading engine, and all parts codes of said each vehicle identification number are sorted as a parts code set corresponding to said each vehicle identification number.

Specifically, all OE results of each VIN in the VIN-OE database are obtained by using a VIN-OE data loading engine, and the OE results of each VIN are sorted as an OE set corresponding to each VIN. For example, the OE set is defined as key_MD5{oe1, oe2, oe3 . . . , oen}, where n is a natural number.

For the sorting manner, as an example, all parts codes may be arranged in an ascending order according to the letters or data of their contents under the vehicle identification number, and then aggregated to form a parts code set. Through this sorting, it is convenient to compare the same parts code sets and avoid the interference caused by the comparison based on the out-of-order such as {oe1, oe2, oe3} and {oe2, oe1, oe3}.

S102 is a merging step.

A plurality of the vehicle identification numbers satisfying a predetermined condition is merged. For the predetermined condition, a plurality of the vehicle identification numbers corresponding to the same parts code set may be merged. That is, a plurality of VINs corresponding to the same OE set is merged.

As an example, referring to for example FIG. 1, the OE set corresponding to VIN1 is the OE set A: key_MD5{oe1, oe2, oe3 . . . , oen}, and the OE set corresponding to VIN2 is also the OE set A: key_MD5{oe1, oe2, oe3 . . . , oen}, then VIN1 and VIN2 may be merged.

The OE set corresponding to VIN3 is the OE set B: key_MD5′{oe1, oe2, oe3′ . . . , oen}, and the OE set corresponding to VIN4 is also the OE set B: key_MD5′{oe1, oe2, oe3′ . . . , oen}, then VIN3 and VIN4 may be merged.

As shown in FIG. 3, as an embodiment of the presently disclosed subject matter, the method for creating a quantum vehicle model parts basic database according to the presently disclosed subject matter may further include the following Steps S201-S202.

S201 is an OE set replacement step.

Different OE codes representing the same product are replaced with standard OE codes OEₛ in the obtained OE set after merging the plurality of VINs, so as to obtain a standardized OE set. Among them, the standard OE code OEₛ may be the latest OE code in different OE codes representing the same product, and the standard OE code OEₛ may also be defined according to user needs.

Specifically, there is a replacement relationship between OE codes. For example, headlights of Audi A6L have three OE codes, L4F0941003BP, L4F0941003CP and L4FD941003D. Three pieces of information are seen from the perspective of OE codes, but in fact, there is a replacement relationship between the three OEs in usage scenarios, i.e., L4F0941003BP=L4F0941003CP=L4FD941003D. Therefore, the oe with a replacement relationship such as L4F0941003BP or L4F0941003CP or L4FD941003D may be uniformly replaced with L4FD941003D (the latest oe) as the standard OE code OEₛ for headlights of Audi A6L. Preferably, the replacement relationship and the standard OE code are based on the official replacement information of the OE codes.

As an example, as shown

in FIG. 1 for example, the OE set corresponding to VIN3 is the OE set B: key_MD5′{oe1, oe2, oe3′ . . . , oen}, in which, there is a replacement relationship between oe3′ and oe3, and oe3 is the preset standard OE code of oe3′. Therefore, in Step S201, the OE set corresponding to VIN3 is replaced with the standardized OE set key_MD5{oe1, oe2, oe3 . . . , oen}. Likewise, the OE set B corresponding to VIN4 is also replaced with the standardized OE set key_MD5{oe1,oe2,oe3 . . . , oen}.

S202 is a re-merging step.

In Step S201, the VINs that have been merged are re-merged in the case of obtaining the standardized OE set through replacement.

As an example, referring to for example FIG. 1, in Step S201, after VIN3 and VIN4 are replaced with the standardized OE set, the OE sets corresponding to VIN1, VIN2 and VIN3, VIN4 are all the OE set key_MD5{oe1, oe2, oe3 . . . , oen}. Therefore, in Step S202, VIN1, VIN2 and VIN3, VIN4 corresponding to the OE set key_MD5{oe1, oe2, oe3 . . . , oen} may be re-merged.

By using the above Steps S201-S202, the OE set can be standardized to further merge VINs, thereby further reducing the data storage amount under the premise of ensuring that the data accuracy is completely the same as that of the single VIN.

S103 is a verification step.

The merging results are verified by determining whether the preset index is qualified using a preset verification model.

As shown in FIG. 4, as an embodiment of the presently disclosed subject matter, the verification step S103 includes the following Steps S301-S302:

S301 is an index verification step.

It is determined whether a preset index under the merging results reaches a predetermined threshold to determine whether the merging results are qualified. That is, the obtained relationship between the merged VIN-key_MD5 and key_MD5-OE is verified to determine whether the preset index reaches the corresponding threshold.

Specifically, the VIN-OE database of each brand is used to verify the relationship between VIN-key_MD5 and key_MD5-OE merged in Step S102 or S202 to determine whether the preset indexes such as the OE quantity, the VIN quantity, and the OE uniqueness rate reach the preset thresholds. When the indexes such as the OE quantity, the VIN quantity, and the OE uniqueness rate reach the preset thresholds, it is determined that the obtained relationship between the merged VIN-key_MD5 and key_MD5-OE is qualified; otherwise it is determined to be unqualified.

Among them, the OE quantity refers to the number of OEs in the OE set under a single VIN; the VIN quantity refers to the number of VINs merged together corresponding to the single key_MD5; and the OE uniqueness rate refers to the ratio of the number of standard names only corresponding to the unique OE under the single key_MD5 to the number of all standard names under the single key_MD5.

As the above preset thresholds, for example, the number of OEs may be set to 600; the number of VINs may be set to 100, and the OE uniqueness rate may be set to 90%. Moreover, the optimal thresholds may be set according to the differences of respective brands and their respective situations.

S302 is a sales version information verification step.

A sales vehicle model database is called to obtain sales version information corresponding to all of the vehicle identification numbers under each of the merging results, and it is determined whether the sales version information corresponding to all of the vehicle identification numbers under each of the merging results is unique. That is, a VIN-SID (sales vehicle model) database is called to obtain SIDs and sales version information corresponding to all VINs under key_MD5, and it is determined whether the sales version information corresponding to all VINs under the same key_MD5 is unique. Among them, the sales version information belongs to a part of the SID sales vehicle model, and on the basis of the SID sales vehicle model, it removes some information unrelated to parts, such as the fact that the production year of the American brand does not affect OE code. If the sales version information corresponding to all VINs under each key_MD5 is unique, that is, all VINs under each key_MD5 respectively have unique sales version information, then it is determined that the relationship between the above VIN-key_MD5 and key_MD5-0E is qualified. If the sales version information corresponding to all VINs under key_MD5 is not unique, then it is determined that the relationship between the above VIN-key_MD5 and key_MD5-0E is unqualified.

According to the above embodiment, each index and its threshold can be flexibly set according to the data characteristics, thereby improving the verification efficiency, and the VIN-SID database can be called to verify the relationship between the merged VIN-key_MD5 and key_MD5-0E again, so as to improve the accuracy of the data.

As shown in FIG. 5, as an embodiment of the presently disclosed subject matter, the method for creating a quantum vehicle model parts basic database according to the presently disclosed subject matter may further include the following steps:

S401 is a manual optimization step.

When it is determined that the obtained relationship between the merged VIN-key_MD5 and key_MD5-OE is unqualified (uniqueness verification is unqualified or sales version information verification is unqualified), the fix processing is performed on unqualified data, and merging and verification are performed again after fixing until the data are qualified.

S104 is a VID generation step.

The merging results are encoded when it is verified that the merging results are qualified, so as to obtain the quantum vehicle model parts basic database taking the merging results as a dimension. That is, VID encoding is performed on the key_MD5 when it is determined that the obtained relationship between the merged VIN-key_MD5 and key_MD5-OE is qualified, so as to obtain the quantum vehicle model parts basic database with VID as a dimension.

Each step in a preferred embodiment of a method for creating a quantum vehicle model parts basic database according to the presently disclosed subject matter is described above. With the method for creating a quantum vehicle model parts basic database according to the presently disclosed subject matter, the quantum library is obtained by processing and calculation on the massive hundred-billion-level OEs of the hundred-million-level VINs with a high-performance calculation architecture; the massive data of the quantum library are stored in a unique high compression data format, and 100 TB data are compressed to 1 TB to be basically stored in the database, which solves the contradiction between “completely retaining the VIN accuracy” and “the amount of data being too large to use, resulting in no business attributes” in the traditional basic database. Therefore, under the premise of ensuring that the data accuracy is completely the same as the single VIN accuracy, the disadvantage that the amount of data for single VIN storage is too large to be called can be avoided, and the accuracy and the practicability are integrated. Specifically, the quantum library of the presently disclosed subject matter encodes and merges all vehicle parts, and then under the premise of ensuring that the data accuracy is unchanged, provides the most fine-grained vehicle model parts query capability, which greatly reduces the amount of the vehicle model maintenance and makes the amount of data reduced from a hundred-million level to a million level, thereby facilitating secondary processing and trend mining of data in different usage scenarios.

In addition, as shown in FIG. 6, the method for creating a quantum vehicle model parts basic database according to the presently disclosed subject matter further includes: Step S501, a static deployment step; and Step S502, a quantum library query engine calling step.

S501 is a static deployment step.

The quantum vehicle model parts basic database obtained through the above Steps S101-S104 is selectively transmitted and saved to a user internal network, for static deployment to the user internal network.

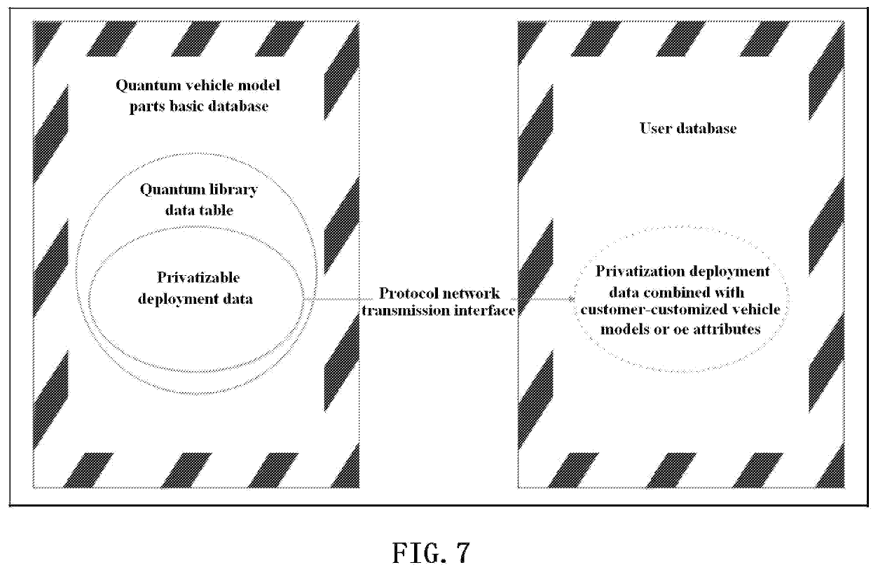

Thus, as shown in FIG. 7, users may obtain only a part (privatizable deployment data) that the user needs in the aforesaid quantum vehicle model parts basic database according to their own requirements, without needing the entire database with a large amount of data storage. Moreover, if users need to use the VIN-OE data in a certain link that requires data, such as loss assessment/risk control, etc., they can query the corresponding VIN-VID relationship directly by inputting VIN in an intranet, and further query the corresponding relationship of VID-OE, so as to directly query the OE and relevant attribute information thereof corresponding to the VIN in the privatizable deployment data of the intranet, without accessing the extranet, thereby achieving the good effects of rapid, safe, efficient and stable data query, and facilitating data upgrading and maintenance through network transmission.

S502 is a quantum library query engine calling step.

In the case that a user cannot query the corresponding VIN-VID relationship on the intranet, or there is no static deployment of the intranet (i.e., in the case of direct extranet connection), the user may call the quantum library query engine, take VIN (and the corresponding query method, such as parts names and other additional information), etc. as input parameters, and use the quantum library query engine to query the quantum vehicle model parts basic database, so as to obtain the VID corresponding to the VIN, and then obtain the corresponding OE and attribute information thereof, and may further use the additional information such as a parts name for screening to obtain a final query result.

As shown in FIG. 8, the method for creating a quantum vehicle model parts basic database according to the presently disclosed subject matter further includes the following step:

S601 is a vehicle model correlation step.

Based on the correspondence between VIN-VID, VIN-vehicle model (SID) and VID-OE, the correspondence of vehicle model-VID-OE is established, so that the quantum parts basic database can be queried based on the vehicle model to obtain the VID corresponding to the vehicle model, and then obtain the corresponding OE and attributes thereof. In addition, the user may also perform a privatization deployment in a vehicle model dimension.

When users input a vehicle model rather than a VIN for query, they can directly obtain the VIN corresponding to the input vehicle model based on the vehicle model-VID-OE relationship, and then obtain the corresponding OE and attributes thereof.

According to the above embodiment, the corresponding OE and attribute information thereof can be quickly and efficiently obtained in a case of inputting the vehicle model rather than the VIN for query, so that it is convenient for users to input various types of information for query according to their needs, and the user convenience is improved. It needs to be pointed out that the relationship between other relevant parameters and VID can be established without being limited to the vehicle model information, and then the VID and the corresponding OE and attributes thereof can be queried by inputting the other parameters.

According to the above embodiment, the database table of the unified model can be used to make a coverage range of the underlying basic data include all passenger vehicles. The underlying basic data may include the correspondence between vehicles and parts, and may also include parts attribute information (including usage amount of a single vehicle, pictures, replacement relationships, materials, maintenance types), prices, working hours, and serve for the fields of insurance, post-markets and maintenance, thereby providing transaction-level data with high resolution, high precision, and high timeliness.

In another aspect, embodiments of the presently disclosed subject matter further provide an apparatus for creating a quantum vehicle model parts basic database.

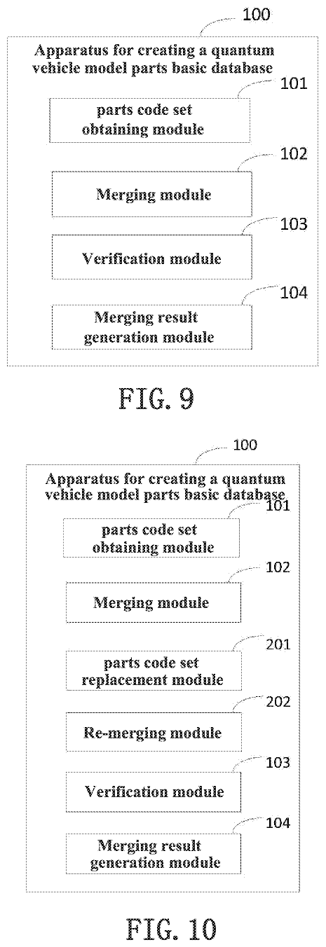

FIG. 9 is a schematic block diagram for a configuration of an apparatus for creating a quantum vehicle model parts basic database according to a preferred embodiment of the presently disclosed subject matter. As shown in FIG. 9, the apparatus for creating a quantum vehicle model parts basic database according to an embodiment of the presently disclosed subject matter includes: 101, a parts code set obtaining module; 102, a merging module; 103, a verification module; and 104, a merging result generation module.

As shown in FIG. 10, as a preferred embodiment, the apparatus for creating a quantum vehicle model parts basic database according to the presently disclosed subject matter further includes: 201, a parts code set replacement module; and 202, a re-merging module.

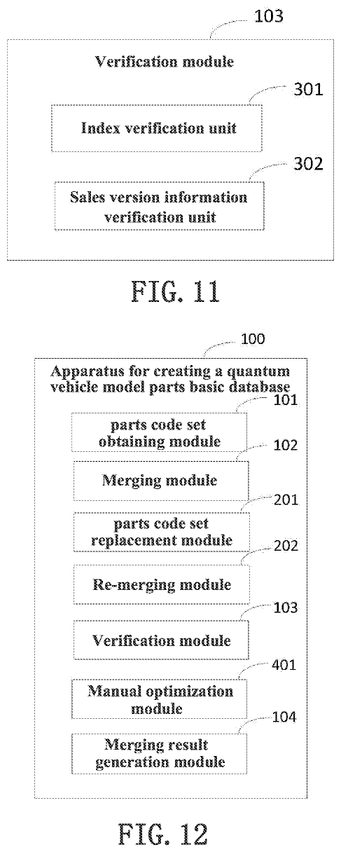

As shown in FIG. 11, as a preferred embodiment, the verification module 103 according to the presently disclosed subject matter includes: an index verification unit 301 and a sales version information verification unit 302.

As shown in FIG. 12, as a preferred embodiment, the apparatus for creating a quantum vehicle model parts basic database according to the presently disclosed subject matter further includes: 401, a manual optimization module.

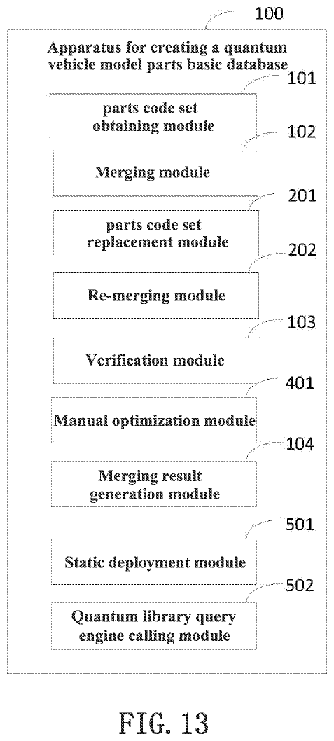

As shown in FIG. 13, as a preferred embodiment, the apparatus for creating a quantum vehicle model parts basic database according to the presently disclosed subject matter further includes: 501, a static deployment module; and 502, a quantum library query engine calling module.

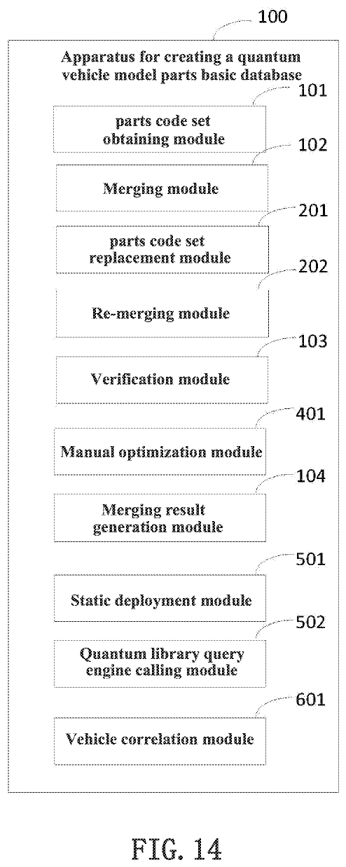

As shown in FIG. 14, as a preferred embodiment, the apparatus for creating a quantum vehicle model parts basic database according to the presently disclosed subject matter further includes: 601, a vehicle model correlation module.

Each module above will be described below in detail.

101 is an parts code set obtaining module.

The parts code set obtaining module 101 is configured to obtain all parts codes of each vehicle identification number in a database by using a data loading engine, and sort all parts codes of said each vehicle identification number as a parts code set corresponding to said each vehicle identification number.

Specifically, the parts code set obtaining module 101 obtains all OE results of each VIN in the VIN-OE database by using a VIN-OE data loading engine, and sorts the OE results of each VIN as an OE set corresponding to each VIN. For example, the OE set is defined as key_MD5{oe1, oe2, oe3 . . . , oen}, where n is a natural number.

For the sorting manner, as an example, all parts codes may be arranged in an ascending order according to the letters or data of their contents under the vehicle identification number, and then aggregated to form a parts code set. Through this sorting, it is convenient to compare the same parts code set and avoid the interference caused by the comparison based on the out-of-order such as {oe1, oe2, oe3} and {oe2, oe1, oe3}.

102 is a merging module.

The merging module 102 is configured to merge a plurality of the vehicle identification numbers satisfying a predetermined condition. For the predetermined condition, the merging module 102 may merge a plurality of the vehicle identification numbers corresponding to the same parts code set, i.e., merge a plurality of VINs corresponding to the same OE set.

As an example, referring to for example FIG. 1, the OE set corresponding to VIN1 is the OE set A: key_MD5{oe1, oe2, oe3 . . . , oen}, and the OE set corresponding to VIN2 is also the OE set A: key_MD5{oe1, oe2, oe3 . . . , oen}, then VIN1 and VIN2 may be merged.

The OE set corresponding to VIN3 is the OE set B: key_MD5′{oe1, oe2, oe3′ . . . , oen}, and the OE set corresponding to VIN4 is also the OE set B: key_MD5′{oe1, oe2, oe3′ . . . , oen}, then VIN3 and VIN4 may be merged.

As shown in FIG. 10, as an embodiment of the presently disclosed subject matter, the apparatus for creating a quantum vehicle model parts basic database according to the presently disclosed subject matter may further include the following modules 201-202.

201 is a parts code set replacement module.

The parts code set replacement module 201 is configured to replace different OE codes representing the same product with standard OE codes OEₛ in the obtained OE set after merging the plurality of VINs, so as to obtain a standardized OE set. Among them, the standard OE code OEₛ may be the latest OE code in different OE codes representing the same product, and the standard OE code OEₛ may also be defined according to user needs.

Specifically, there is a replacement relationship between OE codes. For example, headlights of Audi A6L have three OE codes, L4F0941003BP, L4F0941003CP, and L4FD941003D. Three pieces of information are seen from the perspective of OE codes, but in fact, there is a replacement relationship between the three OEₛ in usage scenarios, i.e., L4F0941003BP=L4F0941003CP=L4FD941003D. Therefore, the oe with a replacement relationship such as L4F0941003BP or L4F0941003CP or L4FD941003D may be uniformly replaced with L4FD941003D (the latest oe) as the standard OE code OEₛ for headlights of Audi A6L. Preferably, the replacement relationship and standard OE code are based on the official replacement information of the OE codes.

As an example, as shown in FIG. 1 for example, the OE set corresponding to VIN3 is the OE set B: key_MD5′{oe1, oe2, oe3′ . . . , oen}, in which, there is a replacement relationship between oe3′ and oe3, and oe3 is the preset standard OE code of oe3′. Therefore, the module 201 replaces the OE set corresponding to VIN3 with the standard OE set key_MD5{oe1, oe2, oe3 . . . , oen}. Likewise, the OE set B corresponding to VIN4 is also replaced with the standardized OE set key_MD5{oe1, oe2, oe3 . . . , oen}.

202 is a re-merging module.

The re-merging module 202 is configured to re-merge the VINs that have been merged, in the case that the module 201 obtains a standardized OE set through replacement.

As an example, referring to for example FIG. 1, after the module 201 replaces VIN3 and VIN4 with the standardized OE set, the OE sets corresponding to VIN1, VIN2 and VIN3, VIN4 are all the OE set key_MD5{oe1, oe2, oe3 . . . , oen}. Therefore, the module 202 may re-merge the VIN1, VIN2 and VIN3, VIN4 corresponding to the OE set key_MD5{oe1, oe2, oe3 . . . , oen}.

By using the above modules 201-202, the OE set can be standardized to further merge VINs, thereby further reducing the data storage amount under the premise of ensuring that the data accuracy is completely the same as that of the single VIN.

103 is a verification module.

The verification module 103 is configured to verify the merging results by determining whether the preset index is qualified using a preset verification model.

As shown in FIG. 11, as an embodiment of the presently disclosed subject matter, the verification module 103 includes the following units 301-302:

301 is an index verification unit.

The index verification unit 301 is configured to determine whether a preset index under the merging results reaches a predetermined threshold so as to determine whether the merging results are qualified. That is, the obtained relationship between the merged VIN-key_MD5 and key_MD5-OE is verified to determine whether the preset index reaches the corresponding threshold.

Specifically, the index verification unit 301 uses the VIN-OE database of each brand to verify the relationship between VIN-key_MD5 and key_MD5-OE merged through the module 102 or 202 to determine whether the preset indexes such as the OE quantity, the VIN quantity, and the OE uniqueness rate reach the preset thresholds. When the indexes such as the OE quantity, the VIN quantity, and the OE uniqueness rate reach the preset thresholds, it is determined that the obtained relationship between the merged VIN-key_MD5 and key_MD5-OE is qualified; otherwise it is determined to be unqualified.

Among them, the OE quantity refers to the number of OEs in the OE set under a single VIN; the VIN quantity refers to the number of VINs merged together corresponding to the single key_MD5; and the OE uniqueness rate refers to the ratio of the number of standard names only corresponding to the unique OE under the single key_MD5 to the number of all standard names under the single key_MD5.

As the above preset thresholds, for example, the number of OEs may be set to 600; the number of VINs may be set to 100, and the OE uniqueness rate may be set to 90%. Moreover, the optimal thresholds may be set according to the differences of respective brands and their respective situations.

302 is a sales version information verification unit.

The sales version information verification unit 302 is configured to call a sales vehicle model database to obtain sales version information corresponding to all of the vehicle identification numbers under each of the merging results, and determine whether the sales version information corresponding to all of the vehicle identification numbers under each of the merging results is unique. That is, the sales version information verification unit 302 calls a VIN-SID (sales vehicle model) database to obtain SIDs and sales version information corresponding to all VINs under key_MD5, and determines whether the sales version information corresponding to all VINs under the same key_MD5 is unique. Among them, the sales version information belongs to a part of the SID sales vehicle model, and on the basis of the SID sales vehicle model, it removes some information unrelated to parts, such as the fact that the production year of the American brand does not affect OE code. If the sales version information corresponding to all VINs under each key_MD5 is unique, that is, all VINs under each key_MD5 respectively have unique sales version information, and then the sales version information verification unit 302 determines that the relationship between the above VIN-key_MD5 and key_MD5-OE is qualified. If the sales version information corresponding to all VINs under key_MD5 is not unique, then the sales version information verification unit 302 determines that the relationship between the above VIN-key_MD5 and key_MD5-OE is unqualified.

According to the above embodiment, the VIN-SID database can be called to verify the relationship between the merged VIN-key_MD5 and key_MD5-OE again, so as to improve the accuracy of the data.

As shown in FIG. 12, as an embodiment of the presently disclosed subject matter, the apparatus for creating a quantum vehicle model parts basic database according to the presently disclosed subject matter may further include the following modules:

401 is a manual optimization module.

The manual optimization module 401 is configured to perform fix processing on the unqualified data when it is determined that the obtained relationship between the merged VIN-key_MD5 and key_MD5-OE is unqualified (uniqueness verification is unqualified or sales version information verification is unqualified), and perform merging and verification again after fixing until the data are qualified.

104 is a VID generation module.

The VID generation module 104 is configured to encode the merging results when it is verified that the merging results are qualified, so as to obtain the quantum vehicle model parts basic database taking the merging results as a dimension. That is, the VID generation module 104 is configured to perform VID encoding on the key_MD5 when it is determined that the obtained relationship between the merged VIN-key_MD5 and key_MD5-OE is qualified, so as to obtain the quantum vehicle model parts basic database with VID as a dimension.

Each module in a preferred embodiment of an apparatus for creating a quantum vehicle model parts basic database according to the presently disclosed subject matter is described above. The quantum library is obtained by processing and calculation based on the massive hundred-billion-level OE of the hundred-million-level VIN with the apparatus for creating a quantum vehicle model parts basic database according to the presently disclosed subject matter, using a high-performance calculation architecture; the massive data of the quantum library are stored in a unique high compression data format, and 100 TB data are compressed to 1 TB to be basically stored in the database, which solves the contradiction between “completely retaining the VIN accuracy” and “the amount of data being too large to use, resulting in no business attributes” in the traditional basic database. Therefore, under the premise of ensuring that the data accuracy is completely the same as the single VIN accuracy, the disadvantage that the amount of data for single VIN storage is too large to be called can be avoided, and the accuracy and the practicability are integrated. Specifically, the quantum library of the presently disclosed subject matter encodes and merges all vehicle parts, and then under the premise of ensuring that the data accuracy is unchanged, provides the most fine-grained vehicle model parts query capability, which greatly reduces the amount of the vehicle model maintenance and makes the amount of data reduced from a hundred-million level to a million level, thereby facilitating secondary processing and trend mining of data in different usage scenarios.

In addition, as shown in FIG. 13, the apparatus for creating a quantum vehicle model parts basic database according to the presently disclosed subject matter further includes: 501, a static deployment module; and 502, a quantum library query engine calling module.

501 is a static deployment module.

The static deployment module 501 is configured to selectively transmit and save the quantum vehicle model parts basic database obtained by the above modules 101-104 to a user internal network, for static deployment to the user internal network.

Thus, users may obtain only a part (privatizable deployment data) that the user needs in the aforesaid quantum vehicle model parts basic database according to their own requirements, without needing the entire database with a large amount of data storage. Moreover, if users need to use the VIN-OE data in a certain link that requires data, such as loss assessment/risk control, etc., they can query the corresponding VIN-VID relationship directly by inputting VIN in an intranet, and further query the corresponding relationship of VID-OE, so as to directly query the OE and relevant attribute information thereof corresponding to the VIN in the privatizable deployment data of the intranet, without accessing the extranet, thereby achieving the good effects of rapid, safe, efficient and stable data query, and facilitating data upgrading and maintenance through network transmission.

502 is a quantum library query engine calling module.

The quantum library query engine calling module 502 is configured to enable a user to call the quantum library engine in the case that the user cannot query the corresponding VIN-VID relationship on the intranet, or there is no static deployment of the intranet (i.e., in the case of direct extranet connection), take VIN (and the corresponding query method, such as parts names and other additional information), etc. as input parameters, and use the quantum library query engine to query the quantum vehicle model parts basic database, so as to obtain the VID corresponding to the VIN, and then obtain the corresponding OE and attribute information thereof, and may further use the additional information such as a parts name for screening to obtain a final query result.

As shown in FIG. 14, the apparatus for creating a quantum vehicle model parts basic database according to the presently disclosed subject matter further includes the following modules:

601 is a vehicle model correlation module.

The vehicle model correlation module 601 is configured to establish the correspondence of the vehicle model-VID-OE based on the correspondence between VIN-VID, VIN-vehicle model (SID) and VID-OE, so that the quantum parts basic database can be queried based on the vehicle model to obtain the VID corresponding to the vehicle model, and then obtain the corresponding OE and attributes thereof. In addition, the user may also perform a privatization deployment in a vehicle model dimension.

When users input a vehicle model rather than a VIN for query, they can directly obtain the VIN corresponding to the input vehicle model based on the vehicle model-VID-OE relationship, and then obtain the corresponding OE and attributes thereof.

According to the above embodiment, the corresponding OE and attribute information thereof can be quickly and efficiently obtained in a case of inputting the vehicle model rather than the VIN for query, so that it is convenient for users to input various types of information for query according to their needs, and the user convenience is improved. It needs to be pointed out that the relationship between other relevant parameters and VID can be established without being limited to the vehicle model information, and then the VID and the corresponding OE and attributes thereof can be queried by inputting the other parameters.

According to the above embodiment, the database table of the unified model can be used to make the coverage range of the underlying basic data include all passenger vehicles. The underlying basic data may include the correspondence between vehicles and parts, and may also include parts attribute information (including usage amount of a single vehicle, pictures, replacement relationships, materials, maintenance types), prices, working hours, services in insurance, post-markets, maintenance, and other fields, thereby providing transaction-level data with high resolution, high precision, and high timeliness.

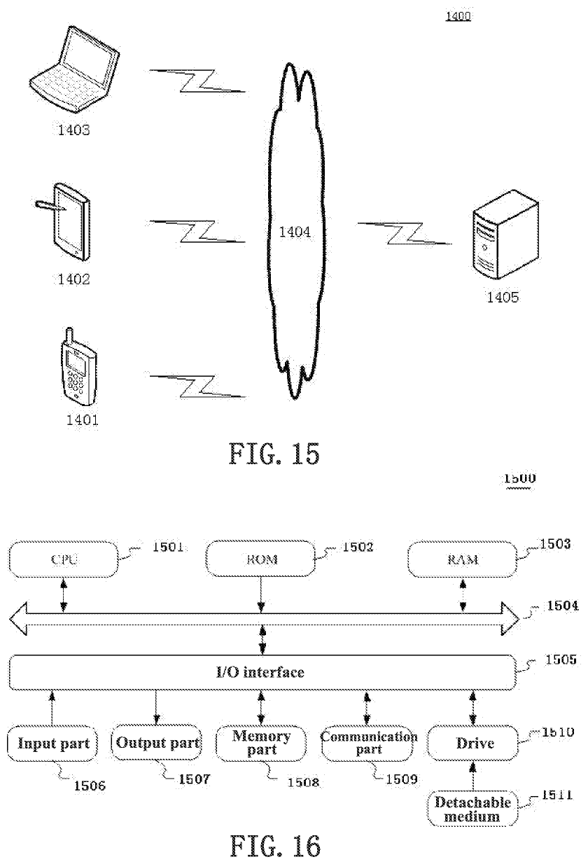

FIG. 15 shows an exemplary system architecture 1400, to which a method or an apparatus for creating a quantum vehicle model parts basic database according to embodiments of the presently disclosed subject matter may be applied.

As shown in FIG. 15, the system architecture 1400 may include terminal devices 1401, 1402 and 1403, a network 1404, and a server 1405 (this architecture is only an example, and the components included in the specific architecture may be adjusted according to specific conditions of the application). The network 1404 is configured to provide a medium of a communication link between the terminal devices 1401, 1402 and 1403 and the server 1405. The network 1404 may include various connection types, such as wired, wireless communication links or optical fiber cables, etc.

The user may use the terminal devices 1401, 1402 and 1403 to interact with the server 1405 through the network 1404 to receive or send messages, etc. Various communication client applications may be installed on the terminal devices 1401, 1402 and 1403, such as shopping applications, web browser applications, search applications, instant messaging tools, email clients, social platform software, etc. (examples only).

The terminal devices 1401, 1402 and 1403 may be various electronic devices having display screens and supporting webpage browsing, including but not limited to smartphones, tablets, laptops, and desktop computers, etc.

The server 1405 may be a server that provides various services, such as a background management server (only an example) that supports shopping websites browsed by users using terminal devices 1401, 1402 and 1403. The background management server may perform analyzing and other processing on the received data such as a product information query request, and feed the processing results (such as target push information, product information—only examples) back to the terminal devices.

It should be noted that the method for creating a quantum vehicle model parts basic database provided in the embodiment of the presently disclosed subject matter is generally performed by the server 1405, and correspondingly the apparatus for creating a quantum vehicle model parts basic database is generally set in the server 1405.

It should be understood that the numbers of the terminal devices, networks and servers in FIG. 15 are merely schematic. According to implementation needs, there may be any number of terminal devices, networks, and servers.

In addition, embodiments of the presently disclosed subject matter further provide a computer system. FIG. 16 is a schematic structural diagram of a computer system suitable for implementing an apparatus for creating a quantum vehicle model parts basic database according to embodiments of the presently disclosed subject matter. The apparatus for creating a quantum vehicle model parts basic database shown in FIG. 16 is merely an example, and should not bring any limitation to the functions and use ranges of the embodiments of the presently disclosed subject matter.

As shown in FIG. 16, the computer system 1500 includes a central processing unit (CPU) 1501 that may perform various appropriate actions and processing according to programs stored in a read-only memory (ROM) 1502 or programs loaded from a storage part 1508 into a random access memory (RAM) 1503. Various programs and data required by the operation of system 1500 are also stored in RAM 1503. CPU 1501, ROM 1502, and RAM 1503 are connected to one another through bus 1504. Input/output (I/O) interface 1505 is also connected to bus 1504.

The following components are connected to the I/O interface 1505: an input part 1506 including a keyboard, a mouse, etc.; an output part 1507 including, for example, a cathode ray tube (CRT), a liquid crystal display (LCD), etc., and a speaker, etc.; a storage part 1508 including a hard disk, etc.; and a communication part 1509 including a network interface card such as a LAN card, a modem, etc. The communication part 1509 performs communication processing via a network such as the Internet. A drive 1510 is also connected to the I/O interface 1505 as required. A detachable medium 1511, such as a magnetic disk, an optical disk, a magneto-optical disk, a semiconductor memory, etc., is installed on the drive 1510 as required so that the computer programs read therefrom can be installed into the storage part 1508 as required.

In particular, according to the embodiments disclosed in the presently disclosed subject matter, the steps described above with reference to the flowchart may be implemented as a computer software program. For example, embodiments disclosed in the presently disclosed subject matter include a computer program product, which includes a computer program carried on a computer readable medium, and the computer program contains a program code for performing the method shown in FIGS. 2-8. In such embodiments, the computer program may be downloaded and installed from the network via the communication part 1509, and/or installed from the detachable medium 1511. When the computer program is executed by the central processing unit (CPU) 1501, the above functions defined in the system of the presently disclosed subject matter are executed.

It should be noted that the computer readable medium shown in the presently disclosed subject matter may be a computer-readable signal medium or a computer-readable storage medium or any combination of the above two. The computer-readable storage medium may be, for example, —but is not limited to—an electrical, magnetic, optical, electromagnetic, infrared, or semiconductor system, apparatus, or device, or any combination of the above. More specific examples of the computer-readable storage medium may include, but are not limited to: a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the presently disclosed subject matter, the computer-readable storage medium may be any tangible medium that contains or stores a program that may be used by or in combination with an instruction execution system, apparatus, or device. Moreover, in the presently disclosed subject matter, the computer-readable signal medium may include a data signal propagated in a baseband or as part of a carrier, where a computer-readable program code is carried. Such a propagated data signal may take a variety of forms, including but not limited to an electromagnetic signal, an optical signal, or any suitable combination of the above. The computer-readable signal medium may also be any computer-readable medium other than a computer-readable storage medium, and the computer-readable medium may send, propagate, or transmit a program for use by or in conjunction with an instruction execution system, apparatus, or device. The program code contained on the computer-readable medium may be transmitted by any suitable medium, including but not limited to: wireless, wire, optical cable, RF, etc., or any suitable combination of the above.

The flowcharts and block diagrams in the accompanying drawings illustrate the system architectures, functions and operations that can be possibly implemented by the method, apparatus and computer program product according to various embodiments of the presently disclosed subject matter. In this regard, each block in the flowcharts or block diagrams may represent a module, a program segment, or part of a code, and the above module, program segment, or part of a code includes one or more executable instructions for implementing specified logical functions. It should also be noted that in some alternative implementations, functions marked in the blocks may also occur in an order different from that marked in the accompanying drawings. For example, two blocks represented in succession may be executed substantially in parallel, and sometimes they may also be executed in an inverse order, which depends on involved functions. It should also be noted that each block in the block diagrams or flowcharts as well as a combination of blocks in the block diagrams or flowcharts may be implemented using a special hardware-based system that executes specified functions or operations, or using a combination of special hardware and computer instructions.

The modules involved and described in the embodiments of the presently disclosed subject matter may be implemented in a software manner, and may also be implemented in a hardware manner. The described modules and their units may also be set in a processor, for example, they may be described as: a processor includes a parts code set obtaining module, a merging module, an index verification module, and a merging result generation module. Among them, the names of these modules do not constitute a limitation on the modules and their units per se in some cases, for example, the parts code set obtaining module may also be described as “a parts code set obtaining unit”.

As another aspect, the presently disclosed subject matter further provides a computer-readable medium, which may be contained in the devices described in the above embodiments, and may also exist alone, without being assembled into the devices. The above computer-readable medium carries one or more programs, and when the above one or more programs are executed by one of the devices, the device includes:
obtaining all parts codes of each vehicle identification number in a database by using a data loading engine, and sorting all parts codes of said each vehicle identification number as a parts code set corresponding to said each vehicle identification number;
merging a plurality of the vehicle identification numbers satisfying a predetermined condition;
determining, by using a preset verification model, whether merging results are qualified; and
encoding the merging results when it is determined that the merging results are qualified, so as to obtain the quantum vehicle model parts basic database taking the merging results as a dimension.

The above descriptions are merely embodiments of the present application and are not intended to limit the presently disclosed subject matter. For those skilled in the art, the presently disclosed subject matter may have various modifications and changes. Any modification, equivalent replacement, or improvement made without departing from the spirit and principle of the presently disclosed subject matter shall fall within the scope of the claims of the presently disclosed subject matter.

1. A method for creating a quantum vehicle model parts basic database, characterized in that the method comprises:
obtaining all parts codes of each vehicle identification number by using a data loading engine, and sorting all parts codes of said each vehicle identification number as an parts code set corresponding to said each vehicle identification number;
merging a plurality of the vehicle identification numbers satisfying a predetermined condition;
determining, by using a preset verification model, whether merging results are qualified; and
encoding the merging results when it is determined that the merging results are qualified, so as to obtain the quantum vehicle model parts basic database taking the merging results as a dimension, wherein,
said determining, by using a preset verification model, whether merging results are qualified comprises:
determining whether a preset index under the merging results reaches a predetermined threshold, so as to determine whether the merging results are qualified; and
calling a sales vehicle model database to obtain sales version information corresponding to all of the vehicle identification numbers under each of the merging results, and determining whether the sales version information corresponding to all of the vehicle identification numbers under each of the merging results is unique, so as to determine whether the merging results are qualified.

2. The method according to claim 1, characterized in that the method further comprises:
replacing different parts codes representing the same product with standard parts codes in the parts code set after merging the plurality of the vehicle identification numbers, so as to obtain a standardized parts code set; and
re-merging the vehicle identification numbers that have been merged, according to the predetermined condition based on the replaced standardized parts code set.

3. The method according to claim 1, characterized in that wherein said merging a plurality of the vehicle identification numbers satisfying a predetermined condition comprises:
merging a plurality of the vehicle identification numbers corresponding to the same parts code set.

4. The method according to claim 1, characterized in that the method further comprises:
manually fixing unqualified data when it is determined that the merging results are unqualified.

5. The method according to claim 4, characterized in that the method further comprises:
selectively transmitting and saving the quantum vehicle model parts basic database to a user internal network, for static deployment to the user internal network.

6. The method according to claim 5, characterized in that the method further comprises:
taking the vehicle identification numbers as an input parameter, and calling a quantum library query engine to query the quantum vehicle model parts basic database, so as to obtain the merging results corresponding to the vehicle identification numbers as the input parameter, and then obtain parts codes and attributes thereof corresponding to the merging results.

7. The method according to claim 1, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

8. The method according to claim 3, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

9. The method according to claim 4, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

10. The method according to claim 5, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

11. The method according to claim 6, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

12. An apparatus for creating a quantum vehicle model parts basic database, characterized in that the apparatus comprises:
a parts code set obtaining module, configured to obtain all parts codes of each vehicle identification number by using a data loading engine, and sort all parts codes of said each vehicle identification number as a parts code set corresponding to said each vehicle identification number;
a merging module, configured to merge a plurality of the vehicle identification numbers satisfying a predetermined condition;
a verification module, configured to determine, by using a preset verification model, whether merging results are qualified; and
a merging result generation module, configured to encode the merging results when it is verified that the merging results are qualified, so as to obtain the quantum vehicle model parts basic database taking the merging results as a dimension,
wherein, the verification module comprises:
an index verification unit, configured to determine whether a preset index under the merging results reaches a predetermined threshold, so as to determine whether the merging results are qualified; and
a sales version information verification unit, configured to call a sales vehicle model database to obtain sales version information corresponding to all of the vehicle identification numbers under each of the merging results, and determine whether the sales version information corresponding to all of the vehicle identification numbers under each of the merging results is unique, so as to determine whether the merging results are qualified.

13. The apparatus according to claim 12, characterized in that the apparatus further comprises:
a parts code set replacement module, configured to replace different parts codes representing the same product with standard parts codes in the parts code set after merging the plurality of the vehicle identification numbers, so as to obtain a standardized parts code set; and
a re-merging module, configured to re-merge the vehicle identification numbers that have been merged, according to the predetermined condition based on the replaced standardized parts code set.

14. The apparatus according to claim 12, characterized in that the apparatus further comprises:
a static deployment module, configured to selectively transmit and save the quantum vehicle model parts basic database to a user internal network, for static deployment to the user internal network.

15. An electronic device for creating a quantum vehicle model parts basic database, characterized in that the electronic device comprises a storage unit storing programs and a processing unit, wherein
the processing unit executes the programs to implement each step in the method according to claim 1.

16. A computer-readable storage medium, characterized in that wherein,
the medium has programs stored thereon, the programs being executed to implement each step in the method according to claim 1.

17. The method according to claim 2, characterized in that wherein said merging a plurality of the vehicle identification numbers satisfying a predetermined condition comprises:
merging a plurality of the vehicle identification numbers corresponding to the same parts code set.

18. The method according to claim 2, characterized in that the method further comprises:
manually fixing unqualified data when it is determined that the merging results are unqualified.

19. The method according to claim 2, characterized in that the method further comprises:
establishing a correspondence between the vehicle model and the merging results and the parts code set based on a correspondence between the merging results and the parts code set, a correspondence between the merging results and the vehicle identification numbers, and a correspondence between the vehicle identification numbers and the vehicle models obtained based on the sales vehicle model database, so that the quantum vehicle model parts basic database can be queried based on the vehicle models.

20. The apparatus according to claim 13, characterized in that the apparatus further comprises:
a static deployment module, configured to selectively transmit and save the quantum vehicle model parts basic database to a user internal network, for static deployment to the user internal network.
